(19) United States
(12) Patent Application Publication
(10) Pub. No.: US 2023/0373819 A1
(43) Pub. Date: Nov. 23, 2023

(54) System for Sanitizing Water in a Container

(71) Applicant: Hall Labs LLC, Provo, UT (US)

(72) Inventors: Michael Hall, Provo, UT (US); David R. Hall, Provo, UT (US); Prabhakar Ramaraj, Provo, UT (US)

(73) Assignee: Hall Labs LLC, Provo, UT (US)

(21) Appl. No.: 17/747,492

(22) Filed: May 18, 2022

(51) Int. Cl. C02F 1/02

(52) U.S. Cl. CPC C02F 1/02; C02F 2303/04; C02F 2103/42

(57) ABSTRACT

A system for sanitizing water in a container is disclosed. The system includes a sanitizing chamber, separate from the container, sized to hold a small portion of the water from the container. A first conduit conveys water from the container to the chamber. A second conduit conveys water from the chamber to the container. A pump moves water from the container, through the first conduit into the chamber and from the chamber, through the second conduit into the container. A heater heats the water in the sanitizing chamber to a temperature and for a time sufficient to destroy or deactivate undesirable microorganisms. The first and second conduits each comprise at least one heat exchanger whereby water in the first conduit is heated by the water in the second conduit and water in the second conduit is cooled by water in the first conduit.

### CROSS-REFERENCE TO RELATED APPLICATIONS

This application claims priority to U.S. Provisional Patent Application No. 63/190,056 filed May 18, 2021 and titled “System for Sanitizing Water in a Container,” the entire disclosure of which is incorporated herein by reference.

### TECHNICAL FIELD

The invention relates to systems for cleaning and sanitizing water in containers or water caught and stored in a container.

### BACKGROUND

Humans have been catching and storing water for centuries. Water storage is an important way that humans have taken care to have one of the necessities of life available to them. Water is often stored in open containers. Open containers are not protected from the environment and undesirable microorganisms can land in the water, grow, and cause problems if ingested. Other containers catch water and store that water in closed containers. While such closed containers are not open to the environment themselves, the catching areas for the water are often open to the environment and undesirable microorganisms can hitch a ride into the container and then proliferate in the container.

Many systems have been devised over the years for sanitizing water in tanks and other containers. Most use chemicals, such as chlorine, to kill bacteria and other undesirable microorganisms.

### SUMMARY

In a first aspect, the disclosure provides a system for sanitizing water in a container. The system includes a sanitizing chamber, separate from the container, and sized to hold a small portion of the water from the container. A first conduit conveys water from the container to the sanitizing chamber. A second conduit conveys water from the chamber to the container. A pump is provided that moves water from the container, through the first conduit into the sanitizing chamber and from the sanitizing chamber, through the second conduit into the container. A heater heats the water in the sanitizing chamber to a temperature and for a time sufficient to destroy or deactivate undesirable microorganisms. The first and second conduit each comprise at least one heat exchanger whereby water in the first conduit is heated by the water in the second conduit and water in the second conduit is cooled by water in the first conduit.

Further aspects and embodiments are provided in the foregoing drawings, detailed description and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is a view of a sanitization system for use with a cistern.

FIG. 2 is a graph of various sanitization cycles

FIG. 3 is an exploded view of a heat exchanger.

FIG. 4 is a view of six heat exchangers in series between a container and a sanitizing chamber.

FIG. 5 is a graph of temperature differences between heat exchangers when used in series.

FIG. 6 is a view of one embodiment in use with a swimming pool.

FIG. 7 is a cut away view of an after-market sanitizing unit to be used with an existing hot tub.

FIG. 8 is a perspective view of an after-market sanitizing unit to be used with an existing hot tub.

FIG. 9 is a perspective view of a one embodiment of the system, with the cover and part of the insulation removed to show the internal components.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, the term “undesirable microorganism” is intended to have a relatively broad meaning, referring both to pathogens, namely viruses, bacteria, fungi, protozoa and worms that can cause disease, as well as microorganisms that have other detrimental effects on the quality of the water, namely make the water odorous or unclear.

As used herein, the phrase “destroy or deactivate undesirable microorganisms” is intended to have a relatively broad meaning, not requiring complete elimination of undesirable microorganisms, but reducing levels enough to make a positive impact on the water quality in the container. Naturally, total or near total elimination is most preferred.

As used herein, the phrase “small portion,” as in a “a small portion of the water from the container” is used to express that only a minor portion of the water from the container is held by the sanitizing chamber at a time. Preferably, this amount is less than 20 percent of the water, more preferably less than 10 percent, even more preferably less than 5 percent and most preferably less than 1 percent.

As noted above, the water in a container can provide a haven for many undesirable microorganisms, such as odor causing bacteria and even disease-causing pathogens. Some of the undesirable microorganisms that can grow in water include Legionella, Pseudomonas, Cholera and Cryptosporidium. These microorganisms can cause rashes and illness. They are introduced to the container in a variety of ways. Some are airborne and begin colonizing when the pathogen falls in the water, others are found in soil, and others are found on human skin.

Heat can be an effective method for destroying or deactivating undesirable microorganisms in liquids. Boiling water has been used for centuries to purify water and make it safe to drink. Pasteurization is another method of sanitizing using heat. Pasteurization typically involves heating liquids to below 212° F. (100° C.) and holding them at that temperature for a time sufficient to destroy or deactivate those undesirable microorganisms.

The present invention uses heat to destroy or deactivate undesirable microorganisms, it is different from pasteurization and its use in other liquids. In pasteurization the liquid is heated, either all at once in a vessel, or as it all passes through a conduit. As such, pasteurization is a typically a one-time event. In contrast, the sanitizing system described herein, small volumes of the liquid are sanitized and then returned to the volume of the container. Preferably, this is done as an ongoing process and is not a one-time event.

Containers, particularly open containers are known as good environments for many undesirable microorganisms. Many containers have a large supply of water. In some environments open containers are kept at temperatures where many undesirable microorganisms thrive.

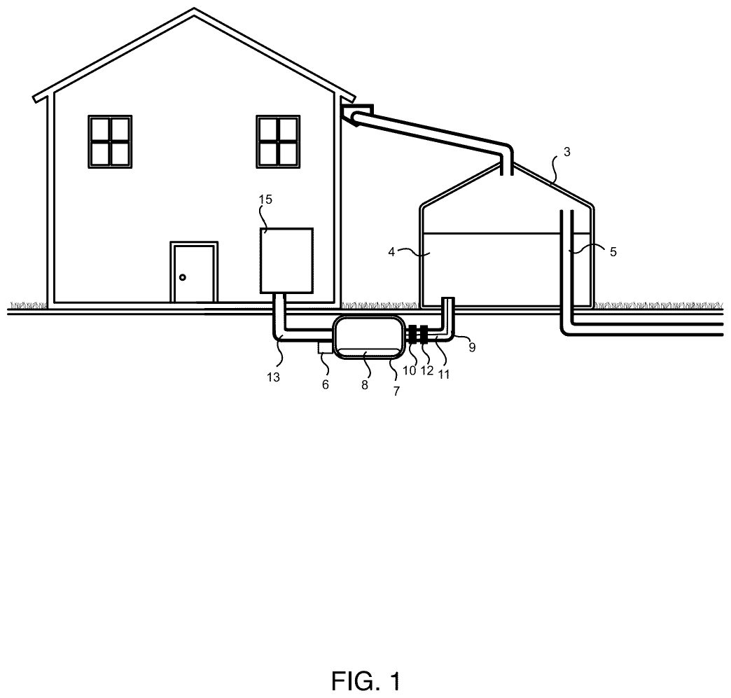

Now referring to FIG. 1, which shows a sanitization system in use with a container. Containers collect and store water. Many containers collect water from locations where undesirable microorganisms thrive, such as roofs or paved areas. Water runs over these areas and collects the undesirable microorganisms on the way to the container. While many collection containers include screens for filtering debris, these screens primarily filter sediment and organic matter, they are not designed to catch microorganisms. Consequently, when the water reaches the container, the microorganisms have not been filtered out and are collected and stored with the water. In the water, the microorganisms can multiply and contaminate all of the water.

One example of such a container is a cistern 3. The cistern holds rainwater collected from the roof of a home and directed to the cistern 3. The cistern 3 contains an overflow drain 5. This overflow keeps the cistern from overfilling and damaging the cistern. The water 4 is stored in the cistern until necessary to use.

The system can be used with a variety of water containers. For example, the water container may be a water storage tank, holding water for human or animal consumption. Such a container may be a cistern filled from catching rainwater or may be filled from a cistern catching rainwater. Additionally, the container may be filled from a well. Water may be pumped into the storage tank from a body of still or moving water. In other embodiments, the container of water is used in aquaponics or aquaculture, thus housing plants or fish. The container may be used for ornamentation or other enjoyment, such as a lily pond, koi pond, or indoor aquarium. In other embodiments, the container of water is a swimming pool, and the sanitizing system of the invention is used as the sole, primary, or secondary means to maintain the pool water safe for swimmers. In one embodiment, the container of water is a hot tub, sometimes referred to as a spa. A hot tub is a large tub filled with water, typically used for relaxation and/or hydrotherapy.

The system continually sanitizes small volumes of the water from the container until all or substantially all of the water has been cycled through the sanitizing system. Also, after conventional pasteurization, the liquid is sealed, so as to prevent re-contamination and often refrigerated. In contrast, the container to which the sanitizing system is attached remains accessible by microorganisms and recontamination. This can be for any of a variety of reasons. The container may be open where the surface of the water is exposed to the environment. Additionally, the container may continuously receive water collected from contaminated sources. As such, the continuous operation of the system is even more advantageous. The sanitizing system includes a sanitizing chamber 7, a pump 6 for moving the water from the cistern 3 to the sanitization chamber 7, a heating element 8, conduits 9 and 11, and heat exchangers 10 and 12. Within the sanitizing chamber 7, the water is heated and held at a temperature sufficiently high to destroy or deactivate the undesirable microorganisms.

The sanitizing chamber 7 needs to be large enough to heat a sufficient volume of water to cycle through the volume of water in the container quickly enough to prevent growth of the undesirable microorganisms, while still being small enough to efficiently heat the full volume of water in the container. In some embodiments, the volume of the sanitizing chamber is between 0.5 liter and 5 liters. In the more preferred embodiment, the chamber is between 0.8 liter and 3 liters. In yet a more preferred embodiment, the chamber is between 1 liter and 2 liters. Stated another way, the small portion of water in the sanitizing chamber is preferably less than 20 percent of the water, more preferably less than 10 percent, even more preferably less than 5 percent and most preferably less than 1 percent.

The sanitizing system includes a heater for heating the water in the sanitizing chamber 7. The heater may be any of a variety of heating methods. In some embodiments, the heating method is a flame-based element such as those found in many water heaters. In other embodiments, the heating method is a resistive heating element. In a yet other embodiments, the heating method is a waterproof resistive element. In another embodiments, the heater is a solar heater. Solar heaters are often used for heating water used for personal hygiene such as bathing and showering. While often used for heating bath water, solar heaters are capable of producing temperatures high enough to destroy or deactivate unwanted microorganisms. There are several solar water heaters available commercially, such as those produced by Duda. Solar water heaters are advantageous for pairing with a container such as a roof mounted rain catchment cistern.

In some embodiments, the components of the sanitizing system are built into the container. In such an embodiment, the components are built as a part of the container at its construction, and do not need to be added onto the container. In other embodiments, the components of the sanitizing system are retrofittable to a container and can be added to an existing container. Such an embodiment enables an existing and in use container to have the components of the sanitizing system attached and incorporated into the container.

The sanitizing chamber needs to be constructed of a material that will hold water and stand up to high temperatures. The type of heating element used for heating the water also influences the material the sanitizing chamber is constructed of. When the heating method is a flame-based element, the sanitizing chamber needs to be constructed of a material that will be able to have a flame heat the chamber and will transfer the heat to the water while not destroying the chamber. Such materials include metals, like copper, steel, stainless steel, aluminum, alloys or combinations of each of these and other metals, as well as some ceramic materials. There are several issues with using a flame-based heating element including needing an attachment for the flammable gas, having the flammable gas available in the location the container is positioned, and the safety of the gas itself. In the preferred embodiment, the heating method is a resistive heating element. Utilizing a resistive heating element enables the chamber to be made of a wide variety of materials, including metals, such as copper, steel, stainless steel, aluminum, alloys or combinations of each of these and other metals, ceramics, and polymers, such as PVC, ABS, and carbon fiber. In one embodiment, the heating method is a waterproof resistive heating element. Utilizing a waterproof resistive heating element further expands the possibilities for the location of the heating method as the waterproof resistive heating element can be placed inside the sanitizing chamber.

In one embodiment, a first conduit 9 conveys water from the cistern 3 to the sanitizing chamber, and a second conduit 11 conveys water from the sanitizing chamber to the container. As the water passes through conduits 9 and 11 the water goes through heat exchangers 10 and 12. The heat exchangers heat the water on the way to the sanitization chamber and cool the water on the way to the cistern 3 and will be discussed in greater depth in subsequent paragraphs. In yet other embodiments, the sanitized water is stored in a second storage container. In embodiments utilizing a second storage container, water is conveyed from the catchment container such as container 3 to the sanitizing chamber 7 by the first conduit 9. When the water has been sanitized it is conveyed by second conduit 11 through the heat exchangers 10 and 12 and then via a bypass to a third conduit 13 for transport to a second storage container 15. In some embodiments, the return through conduit 11 is eliminated and the water is transported directly from the sanitization chamber through conduit 13 to the secondary storage tank. Bypassing the heat exchangers is less energy efficient. Transporting the sanitized water to a second storage unit is beneficial when the water will be used for human consumption. In this way the entire volume of the water that is conveyed to the second storage container 15 is sanitized. When the sanitized water is placed back in the original storage container it is possible that the full volume of the water in the container will not make it through the sanitization chamber. Sanitizing the majority of the water in the container will result in greatly reduced microbial load. However, there is a possibility of a small volume of water, and thus anything in the water, not being processed through the sanitization chamber. This would leave some microorganisms not being eliminated through the sanitization process. Therefore, water treated solely by the sanitization chamber and placed back in the original container should not be used for human consumption.

The conduits are composed of materials designed for transporting water, these materials include metal tubing such as copper, stainless steel, aluminum, polymers such as PVC, and rubber. Each of these materials have benefits and drawbacks. In the preferred embodiment, the conduits are made of a polymer. Polymers are advantageous because they are generally good insulators. By using a polymer, less heat is lost during the time the water is transported from the sanitizing chamber to the container. Polymer conduits are most advantageous in embodiments utilizing heat exchangers, as will be explained later. In some embodiments, heat loss during transport time is not a detriment, in such instances, conduit made from a metal would be more advantageous. The metal conduit could be used specifically to allow heat to escape from the water before reentering the container. Metal conduits are more advantageous in embodiments where the temperature difference between the water temperature in the container and the water temperature in the sanitizing chamber are high, and there are no heat exchangers in the system. Metal conduit may also be used in embodiments with heat exchangers, provided the conduits were wrapped in an insulative material.

There are various temperature schedules for dealing with undesirable microorganisms in water. For example, OSHA recommends raising the temperature of a water heater to 158° F. for 24 hours to destroy or deactivate legionella. In a paper published in Applied and Environmental Microbiology, for pasteurization of drinking water in developing countries, the researchers stated that a temperature of 149° F. for 6 minutes is enough to destroy or deactivate all germs, viruses, and protozoa. “Ciochetti, D. A., and Metcalf, R. H., Pasteurization of Naturally Contaminated Water with Solar Energy, Applied and Environmental Microbiology, 47:223-228, 1984.”

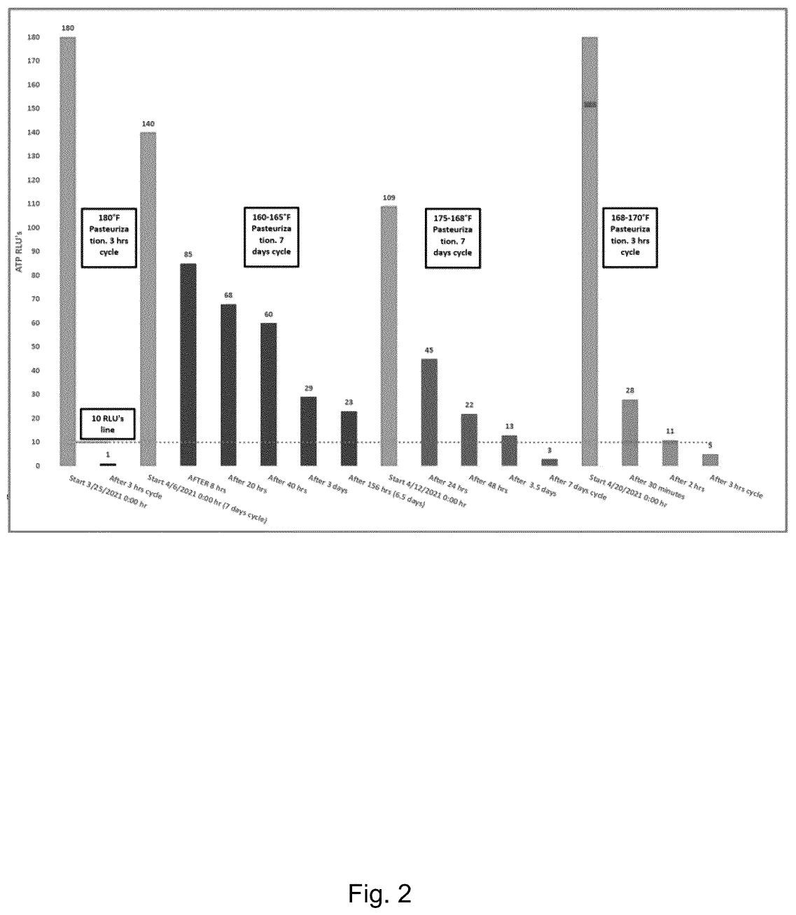

Various temperature and cycle times can be used. Water from the container is conducted from the container, through the first conduit to the sanitizing chamber. In the sanitizing chamber the water is brought to the desired temperature and held at that temperature for a period long enough to destroy or deactivate any undesirable microorganisms. FIG. 2 is a graph of various sanitization cycles used on a hot tub. Temperatures in the sanitizing chamber range from 160-180° F. and hold times range from 10 seconds to one minute. In some embodiments the hold time is between 15 and 45 seconds. In more preferred embodiments, the hold time is between 22 and 38 seconds. In the most preferred embodiment, the hold time is 30 seconds. In some embodiments, the temperature is between 160-180° F. In other embodiments, the temperature is between 164-176° F. In the most preferred embodiment, the temperature is above 168° F. and below 172° F.

In some embodiments, the volume of the container is cycled through the sanitizing chamber over a period between 1 hour and 10 days. In a more preferred embodiment the cycle occurs over a period between 3 and 7 days. In a second more preferred embodiment, the cycle occurs over a 3-hour period. The most preferred method to sanitize the water is to heat the water to between 168-172° F., hold for 30 seconds, and cycle through all the water in the container in 3 hours. The water in the hot tub can be kept sanitized by running cycles through the sanitizing process of the sanitizing chamber. The frequency of the cycles is dependent on use and cleanliness of the water entering the hot tub and the cleanliness of the environment around the container.

The difference between the temperature in the container and the sanitizing chamber is high. Typically, the temperature of the container is dependent upon the ambient temperature at the location of the container, this means that a typical container could have water in it at a temperature just above freezing to a temperature approaching 100° F. In some embodiments the sanitization system could be used to keep water from freezing and thus make it available for a longer period throughout the year. The sanitizer is optimally configured to heat the water to 168-170° F. which leads to a minimum temperature difference of close to 68° F. and a maximum temperature difference of close to 145° F. Heating the water by 68° F. in the sanitizing chamber is inefficient, both in terms of energy input and the time it takes to reach the desired temperature. Increasing the temperature difference by 145° F. would be even more inefficient with regard to the energy input into the system and the time necessary to raise the temperature that amount. To raise the temperature of one gallon of water 1° F. requires 8.33 BTUs. Raising 1 gallon of water 68° F. would require 566 BTUs and raising one gallon of water 145° F. would require 1,208 BTUs. A container holding 500 gallons of water would consume 283,220 BTUs to raise the temperature 68° F. and 603,925 BTUs to raise the temperature 145° F. Additionally, putting the heated water directly back into the container can be dangerous. If someone tries to use the heated water, they can be injured by the incoming heated water.

Utilizing heat exchangers as part of the first and second conduits solves both of these problems. A heat exchanger is a sealed chamber with two sides divided by a thermal conductive plate. There are several options for commercially available heat exchangers, the inventors chose a commercially available brazed plate heat exchanger. A heat exchanger exchanges heat between the water traveling, in the first conduit, from the container to the sanitizing chamber and the water traveling, in the second conduit, from the sanitizing chamber to the container. Water from the container enters one side of the heat exchanger. The water from container is held in the container water side, or first conduit side, of the heat exchanger while water from the sanitizing chamber enters the sanitizing chamber side, or second conduit side, of the heat exchanger. The water from the container and the sanitizing chamber is held in the heat exchanger for a dwell time. During the dwell time the heat from the water on sanitizing chamber side of the exchanger passes through a thermal conductive plate to the water on the container side of the heat exchanger. The water coming from the container is heated. When that water moves to the sanitizing chamber, less energy is used in the sanitizing chamber to bring it up to the appropriate temperature. Simultaneously, the water moving from the sanitizing chamber is cooled and is less dangerous as it moves into the container.

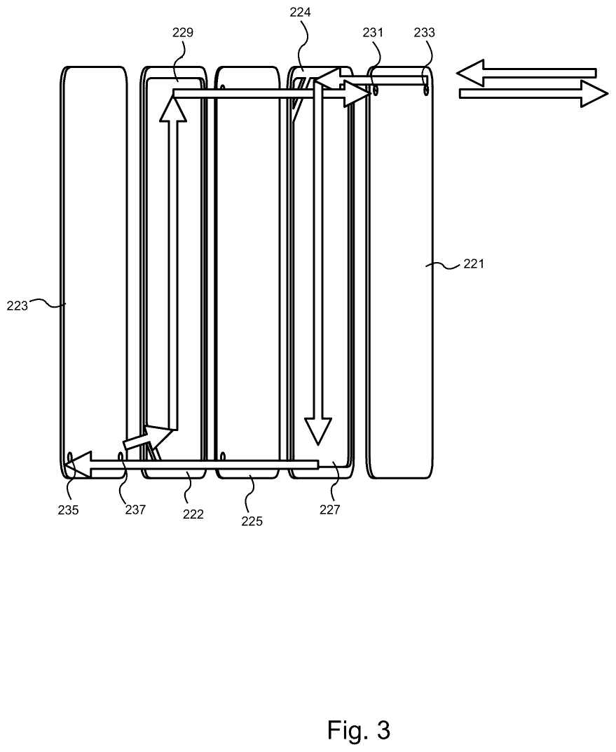

One embodiment of a heat exchanger such as that depicted in FIG. 3, has a first cover plate 221, a second cover plate 223, a thermal conductive plate 225 a first gasket 222 and a second gasket 224. In the space defined by the first cover plate 221, the first gasket 222 and the thermal conductive plate 225 is a first water storage chamber 227. In the space defined by the second cover plate 223, the second gasket 224 and the thermal conductive plate 225 is a second water storage chamber 229. The first cover plate includes an inlet 233 and an outlet 231. The second cover plate includes and inlet 237 and an outlet 235. Water from the container is cycled into the first water storage chamber 227 by passing through the inlet 233 from the container. Simultaneously, water from the sanitizing chamber is cycled into the second water storage chamber 229 through the inlet 237 from the sanitization chamber. The water coming from the sanitization chamber is hotter than the water coming from the container. Heat from the water coming from the sanitization chamber is held in the second water storage chamber 229 and heats the thermal conductive plate 225. The thermal conductive plate 225 then heats the water in the first water storage chamber 227 which was moved from the container. The water is held in the water storage chambers for a set time. This time is generally referred to as a dwell time. Following the dwell time, the water in the first water storage chamber 227 is moved out of the heat exchanger through outlet 35, and the water in the second water storage chamber 229 is moved out of the heat exchanger through outlet 231. While a single heat exchanger does exchange the heat between the two sides of the water, the addition of multiple heat exchangers more effectively cools the water on its way to the container and heats the water on its way to the sanitizing chamber.

The smaller temperature difference provided by utilizing heat exchangers is helpful for conserving energy. The energy to heat up the water on its way to the sanitizing chamber could have been dissipated to the environment, instead it is used to bring the water from the container to a higher temperature so less energy is needed to bring it up to the full sanitizing temperature in the sanitizing chamber.

Throughout the series of heat exchangers, the temperature of the water moving from the sanitizing chamber to the container gets cooler the further from the sanitizing chamber it travels. Each heat exchanger transfers some of the heat to the water that is moving from the container to the sanitizing chamber. The pump used to convey water from the container to the sanitizing chamber and from the sanitizing chamber to the container is programmed to leave the water in the sanitizing chamber and the heat exchangers for a set dwell time. The dwell time for heat to be transferred from the water on its way from the sanitizing chamber to the container to the water on its way from the container to the sanitizing chamber is different from the hold time necessary to destroy or deactivate undesirable microorganisms in the sanitizing chamber. Each heat exchanger holds a smaller volume than the volume of the sanitizing chamber, because of this some of the volume of the water will remain in the sanitizing chamber longer than the hold time for destroying and deactivating unwanted microorganisms. In one embodiment, the pump is programmed to cycle on to move the water through the conduits to each heat exchanger and cycle off to leave the water in the heat exchangers for a programmed dwell time. Different dwell times will result in different temperature changes. The number of heat exchangers also affects the change in temperature.

In one embodiment, a multi-stage heat exchanger is made by stacking the chambers one against the next, so that as the warm water flows from the first chamber to the last it is getting cooled in each stage. Likewise, as the cool water flows in the opposite direction from its first chamber to the last, it is progressively getting cooled. The number of heat exchanging chambers in the stack can be increased to increase the efficiency of the heat recovery provided, with the goal of decreasing the difference in the temperature at the inlet and outlet of the stack. Insulation between the heat exchanging chambers in otherwise adjacent stages is important so that heat is not allowed to travel outside the chambers.

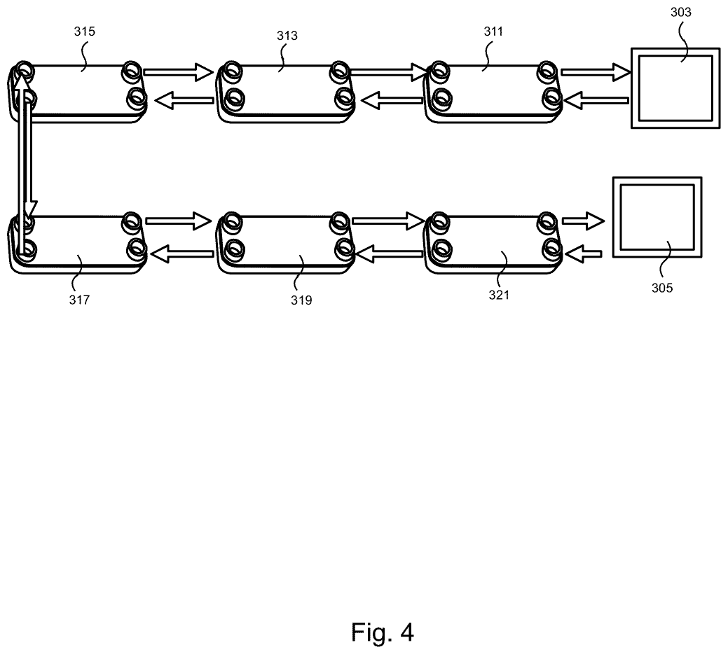

FIG. 4 shows six separate heat exchangers lined up in series to heat the water on its way to the sanitizing chamber and to cool the water on its way to the container. In the embodiment depicted, the heat exchangers are used with a hot tub. The water begins at the hot tub 303. As the water from the hot tub is moved to the first heat exchanger 311. Water from the sanitizing chamber 305 has already passed through five heat exchangers 313, 315, 317, 319, and 321 and transferred much of the heat originally in the water as it left the sanitizing chamber to the water moving from the hot tub 303 to the sanitizing chamber 305. Throughout the series of heat exchangers, the temperature of the water moving from the hot tub 303 to the sanitizing chamber 305 gets hotter the closer to the sanitizing chamber 303 it travels. Simultaneously, the temperature of the water moving from the sanitizing chamber 305 to the hot tub 303 gets colder. Each heat exchanger transfers some of the heat to the water that is moving from the container to the sanitizing chamber 305. In one example, the water in the hot tub begins at 101.8° F. The water from the hot tub enters the first heat exchanger 311 at 101.8° F. In the first heat exchanger the temperature is raised, the average temperature of the water is 103.8° F., this is the average of the temperature of the water coming from the hot tub 303 and the water coming from the sanitization chamber 305. The water from the hot tub is heated by water from the sanitization chamber. The water then moves from the first heat exchanger 311 to the second heat exchanger 313. The average temperature of the water in the second heat exchanger is approximately 116° F. The average temperature of the water in the third heat exchanger 315 is approximately 128° F. The average temperature of the water in the fourth heat exchanger 317 is approximately 140° F. The average temperature of the water in the fifth heat exchanger 319 is approximately 152° F. The average temperature of the water in the sixth heat exchanger 321 is approximately 164° F. The temperature in the sanitization chamber 305 is 170° F. Due to the heat exchangers the water that enters the sanitization chamber only needs to be raised about 6° F. to reach the final sanitization temperature. This means that each gallon of water will require approximately 50 BTUs to reach sanitization temperature. A 500-gallon container would thus require 25,000 BTUs to go through the sanitization process. Without the heat exchangers, the water would need to be heated about 70° F. using about 291,500 BTUs. In other containers such as a cistern or water storage tank that is not kept at a determined temperature, but instead is affected by ambient temperatures, the difference in the temperature of the water from the storage tank to the temperature of the water in the sanitizing chamber can range from 68° F. to 140° F. using from 283,220 BTUs to 603,925 BTUs.

The pump used to convey water from the container to the sanitizing chamber and from the sanitizing chamber to the container is programmed to leave the water in the heat exchangers for a set dwell time. It does this by cycling on to pump the water through the conduit to each heat exchanger and the sanitizing chamber and cycling off to leave the water in the heat exchangers for a dwell time. In one embodiment, the sanitization system is used with six heat exchangers. In one embodiment, the dwell time is between 15 and 45 seconds. In a more preferred embodiment, the dwell time is between 22 and 38 seconds. In the most preferred embodiment, the dwell time is 30 seconds. Different dwell times will result in different temperature changes. The number of heat exchangers also affects the change in temperature.

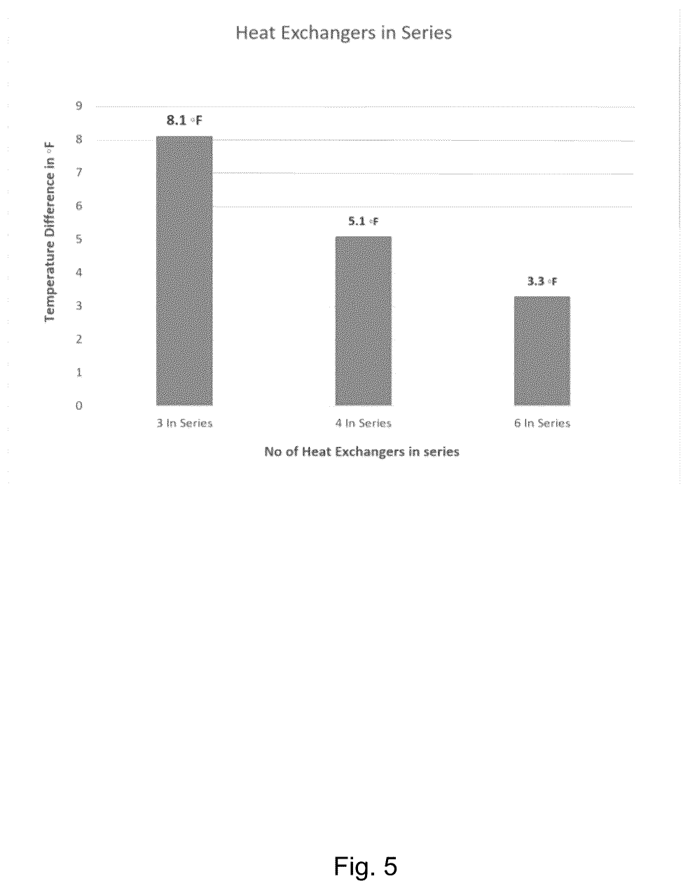

FIG. 5 is a graph depicting the effect of the number of heat exchangers in a sanitization system attached to a hot tub. The flow rate of the pump was set to 320 ml/min, with the pump on for 30 seconds and the pump off for 30 seconds. In one embodiment, three heat exchangers are used with a 30 second dwell time, this results in a temperature difference between the temperature of the water as it exits the hot tub and the temperature of the water as it reenters the hot tub of 8.1° F. In a second embodiment, the number of heat exchangers is four and the temperature difference between the temperature of the water as it exits the hot tub and the temperature of the water as it reenters the hot tub of 5.1° F. In a more preferred embodiment, six heat exchangers and a 30 second dwell time are used, and the difference in temperature between the temperature of the water as it exits the hot tub and the temperature as it reentered the hot tub is 3.3° F. The embodiments here described heat exchangers lined up in a series. One limiting factor to the number of heat exchangers is space. In other words, the heat exchangers need to fit within the space available. With larger space, or with smaller heat exchangers, more heat exchangers can be used. Adding more heat exchangers increases efficiency, because the temperature change between each subsequent heat exchanger decreases. This example was tested on a hot tub; however the principle remains the same for other containers. A container such as a cistern would have a greater temperature difference in the water in the cistern as compared to the water in the sanitizing chamber. Therefore, the temperature difference for each set of heat exchangers would be different, based on the temperature in the container. For example, a container could have water stored at a temperature of 65° F. Using the same parameters as the tested hot tub, a flow rate of 320 ml/min and a dwell time of 30 seconds, the temperature difference for using three heat exchangers would be approximately 12.2° F. The temperature difference for using 4 heat exchangers would be approximately 7.6° F. The temperature difference for using six heat exchangers would be about 5.0° F. Adding more heat exchangers would lower the difference in temperature of the water between the water temperature on leaving the container and the water temperature upon reentering the container.

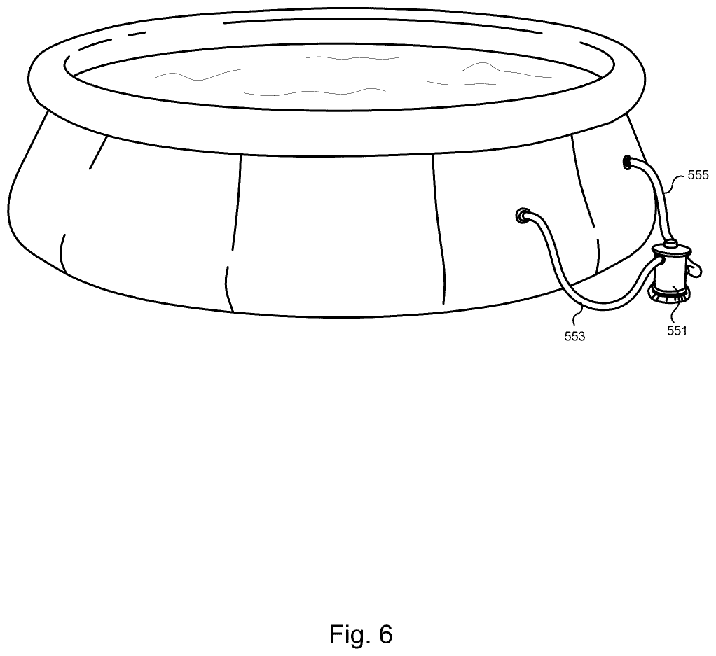

FIG. 6 depicts an embodiment of a sanitization chamber in use with an above ground swimming pool. Water is taken into the sanitization unit 551 through conduit 553 and returned to the swimming pool through conduit 555. The sanitization unit includes a pump, sanitization chamber with heating element, and heat exchangers. The number of heat exchangers in each unit will depend on the size of the unit, and thus the space available for heat exchangers, as well as the cost of the unit. Sanitization units with varying numbers of heat exchangers can be produced. The sanitization unit 551 is a portable unit. Several options for portable sanitization units are possible including battery operated, solar power, battery and solar power, solar heating, propane, and combinations of any or all of these options.

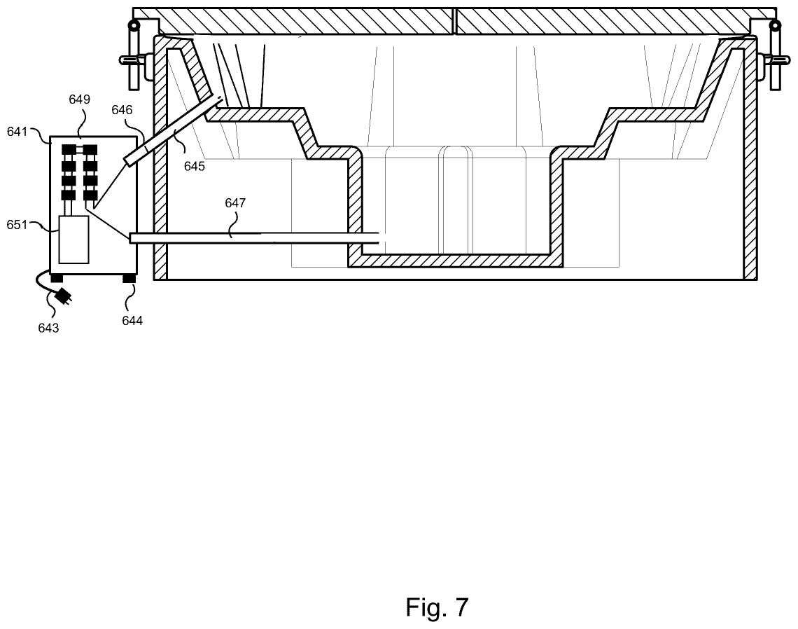

FIG. 7 depicts an internal view of one embodiment which is adapted to be added as an aftermarket device to an existing hot tub. The unit includes a housing 641, with air vents and vibration isolating feet 644. The unit is powered by a cord 643. For safety, it is preferably to include a Ground Fault Current Interrupter (GFCI) device in the cord. Water is brought from the hot tub to the unit through water line 645. Preferably, water line 645 includes a filter 646, such as a simple screen, to prevent solids from entering the unit. Alternatively, a more complex filter, such as a replaceable, pleated cartridge can be put in the line. Water passes through water intake line 645 and passes through a series of heat exchangers 649 on its way to the sanitization chamber 651. Sanitized water is returned to the hot tub through water line 647.

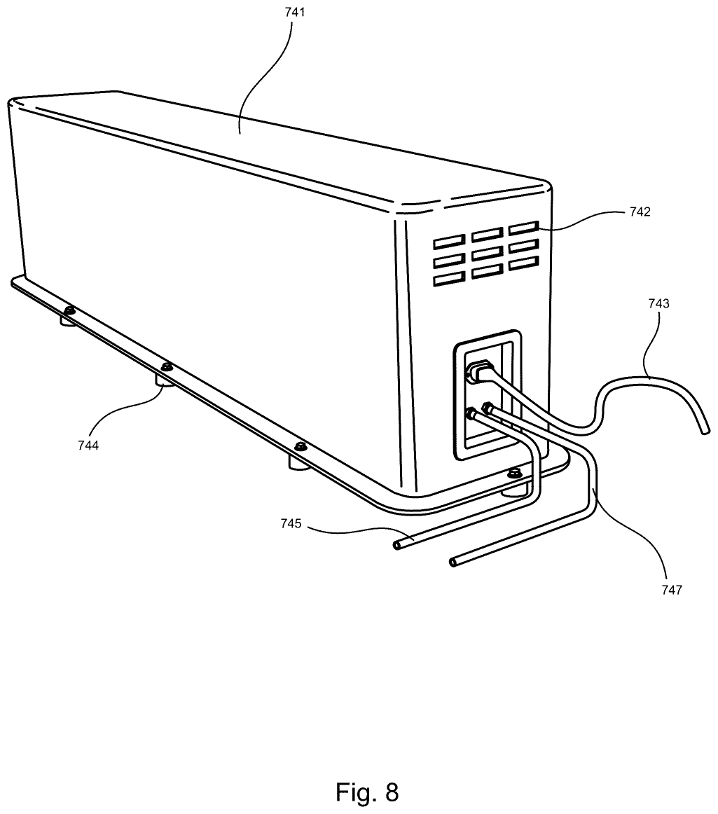

FIG. 8 depicts an outside view of an embodiment of the aftermarket device for use with an existing hot tub. The unit includes a housing 741, with air vents 742 and vibration isolating feet 744. The unit is powered by a cord 743. For safety, it is preferably to include a Ground Fault Current Interrupter (GFCI) device in the cord. Water is brought from the hot tub to the unit through water line 745. Preferably, water line 745 includes a filter, such as a simple screen, to prevent solids from entering the unit. Alternatively, a more complex filter, such as a replaceable, pleated cartridge can be put in the line. Water passes through water intake line 745 and passes through a series of heat exchangers 749 on its way to the sanitization chamber 751. Sanitized water is returned to the hot tub through water line 747.

In other embodiments, the system incorporates or is used with other water filtering or treatment technology, such as ion exchange or electronic descaling to remove minerals.

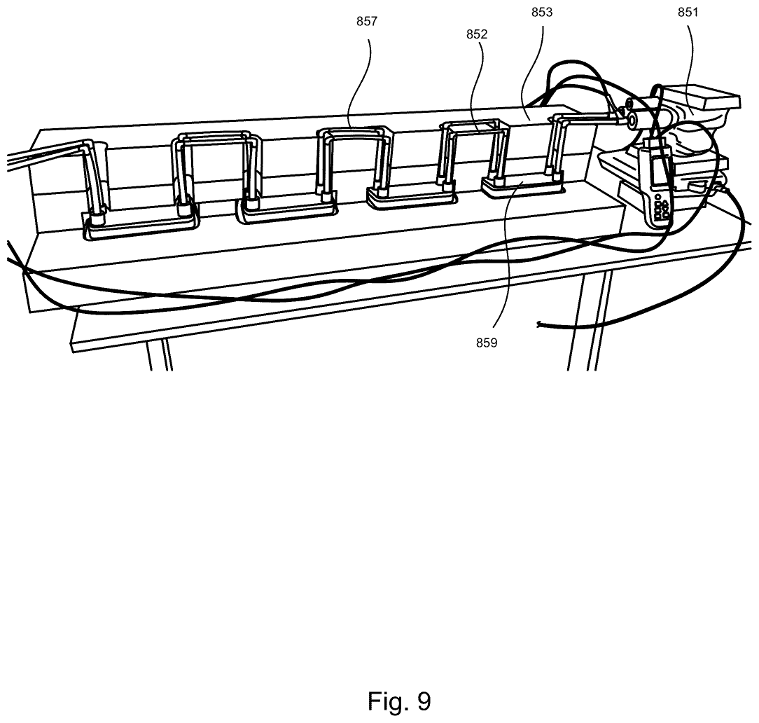

FIG. 9 shows a prototype unit with the housing and some of the insulation removed to show the internal parts. This unit includes a pump and heater 851. A series of four heat exchangers 859 are placed in series and fed water from the container through water lines 855. The water is returned to the container through water lines 857. To avoid heat loss to the environment, the pump, heater, sanitizing chamber, heat exchangers and water lines are all surrounded by a heat insulating material 853, such as polystyrene foam. The wires and gauges shown in FIG. 9 are there for testing.

In the preferred embodiment, the unit is sized and shaped to fit under an existing step for accessing the hot tub. Alternatively, it can be manufactured as a step itself. Still alternatively, it can be manufactured into another hot tub accessory, such as an insulative cover or a drinks and towel stand.

The invention has been described with reference to various specific and preferred embodiments and techniques. Nevertheless, it is understood that many variations and modifications may be made while remaining within the spirit and scope of the invention. Specifically, some embodiments have been described for use with water storage tanks such as cisterns, others have been describes for use with hot tubs, yet others have been described for use with swimming pools. Each of these embodiments can be used interchangeably. For example, the six heat exchanger system can be used on any of a cistern, swimming pool, or hot tub.

All patents and published patent applications referred to herein are incorporated herein by reference. The invention has been described with reference to various specific and preferred embodiments and techniques. Nevertheless, it is understood that many variations and modifications may be made while remaining within the spirit and scope of the invention.

What is claimed is:

1. A system for sanitizing water in a container comprising:
a sanitizing chamber, separate from the container, and sized to hold a small portion of the water from the container;
a first conduit for conveying water from the container to the sanitizing chamber;
a second conduit for conveying water from the chamber to the container;
a pump configured to move water from the container, through the first conduit, into the sanitizing chamber and from the sanitizing chamber, through the second conduit, into the container;
a heater configured to heat the water in the sanitizing chamber to a temperature and for a time sufficient to destroy or deactivate undesirable microorganisms; and
wherein the first and second conduit each comprise at least one heat exchanger whereby water in the first conduit is heated by the water in the second conduit and water in the second conduit is cooled by water in the first conduit.

2. The system of claim 1, wherein the temperature in the sanitizing chamber is above 168° F.

3. The system of claim 1, wherein volume of the sanitizing chamber and rate of the pump is selected to achieve the time sufficient to destroy or deactivate undesirable microorganisms.

4. The system of claim 3, wherein the water is held in in the sanitizing chamber for at least 30 seconds.

5. The system of claim 1, wherein the pump is programed to cycle on and off so that water is held in the sanitizing chamber for the time sufficient to destroy or deactivate undesirable microorganisms.

6. The system of claim 5, wherein the pump is cycled off for between 15 and 45 seconds to achieve the time sufficient to destroy or deactivate undesirable microorganisms.

7. The system of claim 6, wherein the pump is cycled off for 30 seconds.

8. The system of claim 1, wherein the first and second conduits each comprise at least six heat exchangers.

9. The system of claim 1, wherein the first and second conduits each comprise at least 12 heat exchangers.

10. The system of claim 9, wherein the pump is programed to cycle on and off so that water is held in the sanitizing chamber and each of the heat exchangers for a time between 15 and 45 seconds.

11. The system of claim 1, wherein the heater heating water in the sanitizing chamber comprises a resistive heating element.

12. The system of claim 1, wherein the container contains a volume of water and wherein the pump runs at a rate so that the volume pumped into the sanitizing chamber in a period between 3 and 7 days equals the volume of water in the container.

13. The system of claim 1, wherein the container contains a volume of water and wherein the pump runs at a rate so that the volume pumped into the sanitizing chamber in a period between 2 and 4 hours equals the volume of water in the container.

14. The system of claim 1, wherein the container is a water storage tank.

15. The system of claim 1, wherein the container is a cistern.

16. The system of claim 1, wherein the heating element is a solar heater.

17. The system of claim 16, further comprising a second water storage tank, wherein the sanitized water is stored in the second water tank.

18. The system of claim 1, wherein the container is a swimming pool.

19. The system of claim 1, wherein sanitization system is portable.

20. The system of claim 19, wherein the system is battery powered.
